(19) United States
(12) Patent Application Publication
(10) Pub. No.: US 2012/0093308 A1
(43) Pub. Date: Apr. 19, 2012

(54) APPARATUS AND METHOD FOR GENERATING RANDOM DATA

(75) Inventor: Yong Je Choi, Daejeon (KR)

(73) Assignees: Institute, Daejeon (KR); Electronics and Telecommunications Research

(21) Appl. No.: 13/016,015

(22) Filed: Jan. 28, 2011

(30) Foreign Application Priority Data
Oct. 13, 2010 (KR) 10-2010-0099670

(51) Int. Cl. H04L 9/28; H03K 19/20

(52) U.S. Cl. 380/28; 326/104

(57) ABSTRACT

Provided are an apparatus and method for generating random data to be used when masking data to be ciphered. The apparatus for generating random data according to an exemplary embodiment of the present invention is an apparatus for generating a random function using a physically unclonable function (PUF) logic. The apparatus for generating random data logically operates first data and second data using two different types of logic gates, and inverts the logical operation values selected from the logically operated first data and second data every odd sequence and then, inputs them as the second data again, thereby making it possible to form the output data as the random data. The present invention is applied to a data encryption apparatus for encrypting data to prevent a side channel attack.

### BACKGROUND OF THE INVENTION

1. Field of the Invention

The present invention relates to an apparatus and method for generating random data. More particularly, the present invention relates to an apparatus and method for generating random data to be used at the time of masking data to be ciphered.

2. Description of the Related Art

A side channel attack (SCA) is a very powerful analysis mechanism capable of extracting keys or critical data from a cipher algorithm by using side channel information such as power, EM signal, or the like, which are leaked during a process of performing the cipher algorithm. The side channel attack is one of the powerful attack mechanisms against a cipher algorithm and thus, greatly threatens the security products.

In order to protect the security products against any attack, various types of defense mechanisms have been proposed recently. Among those, a masking mechanism is a representative technology of preventing for the side channel attack at an algorithm level. FIG. 1 is a conceptual diagram of an existing masking mechanism.

The masking mechanism is a method that makes it difficult to extract secret information by a statistical analysis of power waveforms or electromagnetic data collected by adding or XORing random data to data to be originally ciphered. Since the values to be masked are any random value, the masking mechanism makes it difficult to perform the statistical analysis for the side channel attack due to random masking data changed every moment even though input data m are known.

In the masking mechanism, it is very important to generate data to be masked so as to have random values. However, when the masking mechanism is implemented in hardware, it is difficult to implement a random function and hardware complexity is increased to increase a volume of a cryptographic operation apparatus.

### SUMMARY OF THE INVENTION

The present invention has been made in effort to provide an apparatus and method for generating random data using physically unclonable function logic.

An exemplary embodiment of the present invention provides an apparatus for generating random data, including: a first logic gate logically operating first data and second data; a second logic gate logically operating the first data and the second data and different from a type of the first logic gate; a logical operation value selector selecting any one of logical operation values from the first logic gate and logical operation values of the second logic gate by using predetermined reference data; a logical operation value controller inputting the selected logical operation values as the second data to the first logic gate and the second logic gate; and a data outputting unit outputting the selected logical operation values as the random data.

The apparatus for generating random data may further include at least two groups including the first logic gate, the second logic gate, and the logical operation value selector, wherein the data outputting unit collects the logical operation values selected from each group and outputs the collected logical operation values as the random data.

The apparatus for generating random data may further include a logical operation value inverter inverting the selected logical operation values and inputting the inverted logical operation values as the second data by the logical operation value controller. The logical operation value inverter may be configured by connecting an odd number of NOT gates in series.

The apparatus for generating random data may further include: a data storage unit storing data; and a data storing controller storing the input data in the data storing unit using a control signal each time the input data are received and storing the second data in the data storage unit using the control signal when the input data are not received. The apparatus for generating random data may further include a mode selector selecting a specific mode among at least two modes by the control signal and guiding the input data or the second data to the data storage unit according to the selected mode. The first logic gate and the second logic gate may use the input data as the first data, and the logical operation value selector first may use the input data as the reference data and then, use the data received from the data storage unit as the reference data.

The first logic gate may be an AND gate and the second logic gate may be an OR gate, and the logical operation value selector may select the logical operation values from the first logic gate when the first data is 1 and select the logical operation values from the second logic gate when the first data is 0.

The apparatus for generating random data may be provided in a data encryption apparatus for encrypting data, and the data encryption apparatus may use the random data output from the data outputting unit when encrypting the data to mask the data to be ciphered. The data encryption apparatus may use symmetric key encryption when encrypting the data.

Another exemplary embodiment of the present invention provides a method for generating random data, including: a first logical operating step of logically operating first data and second data using a first logic gate; a second logical operating step of logically operating the first data and the second data using a second logic gate different from the type of the first logic gate; a logical operation selecting step of selecting any one of the logical operation values from the first logical operating step and the logical operation values from the second logical operation step by using a predetermined reference data; a logical operation inputting step of inputting the selected logical operation values as the second data to the first logical gate and the second logical gate; and a data outputting step of outputting the selected logical operating value as the random data.

The method for generating random data may further include simultaneously performing the first logical operation step, the second logical operation step, the logical operation value step, and the logical operation value inputting step in at least two groups, wherein the data outputting step collects the logical operation values selected from each group and outputs the collected logical operation values as the random data.

The method for generating random data may further include a logical operation value inverting step of inverting the selected logical operation values and inputting the inverted logical operation values as the second data by the logical operation value controller. The logical operation inverting step may include an intermediate step between the logical operation value selecting step and the logical operation value inputting step. The logical operation value inverting step is configured by connecting an odd number of NOT gates in series.

The method for generating random data may further include a data storing step of storing the input data using a control signal each time the input data are received and storing the second data using the control signal when the input data are not received. In the present exemplary embodiment, the case of storing the input data may be implemented by, for example, the preceding step of the first logical operation step and the case of storing the second data by, for example, between the logical operation value selecting step and the logical operation value inputting step. The method for generating random data may further include a mode selecting step of guiding the input data or the second data to the data storage unit storing the data according to a specific mode selected from at least two modes by the control signal. The mode selecting step may be implemented by, for example, the previous step of the data storing step. The first logical operation step and the second logical operation step may use the input data as the first data and the logical operation value selecting step may first use the input data as the reference data and then, use the data received from the data storage unit as the reference data.

The first logic gate may be an AND gate and the second logic gate may be an OR gate, and the logical operation value selecting step may select the logical operation values from the first logic gate when the first data is 1 and select the logical operation values from the second logic gate when the first data is 0.

The method for generating random data may be performed in a data encryption apparatus for encrypting data, and the data encryption apparatus may use the random data output from the data outputting unit when encrypting the data to mask the data to be ciphered.

As set forth above, the present invention generates the random data using the physically unclonable function (PUF) logic to obtain the following effects. First, the present invention can implement the data encryption apparatus safe from the side channel attack. Second, the present invention can implement the random function generating apparatus with the small size and the excellent performance and easily implement the data encryption apparatus with the small size while providing the excellent performance.

### BRIEF DESCRIPTION OF THE DRAWINGS

FIG. 1 is a conceptual diagram of an existing masking mechanism;

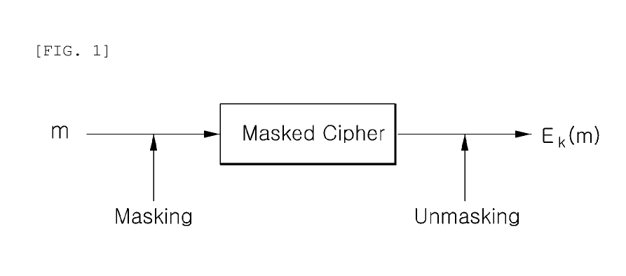

FIG. 2 is a block diagram schematically showing an apparatus for generating random data according to an exemplary embodiment of the present invention;

FIG. 3 is an exemplified diagram of an apparatus for generating random data; and

FIG. 4 is a flow chart schematically showing a method for generating random data according to an exemplary embodiment of the present invention.

### DETAILED DESCRIPTION OF THE EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

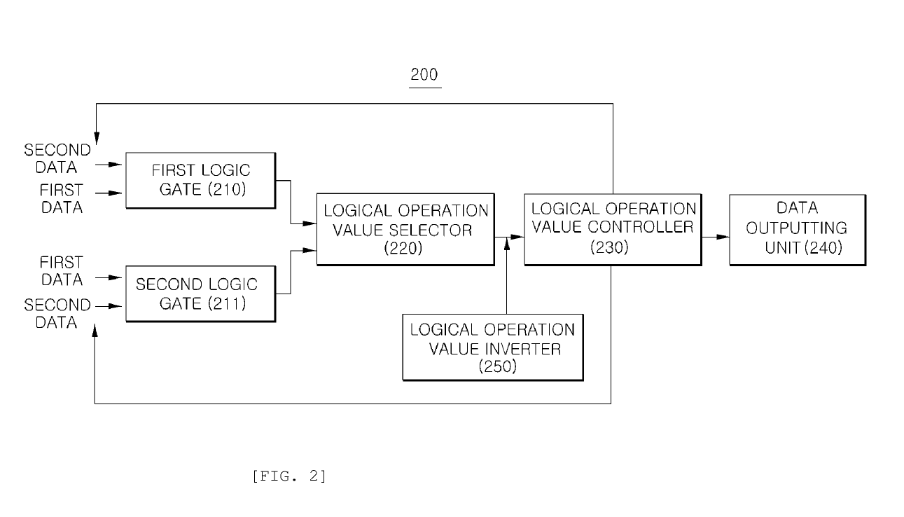

FIG. 2 is a block diagram schematically showing an apparatus for generating random data according to an exemplary embodiment of the present invention. Referring to FIG. 2, an apparatus 200 for generating random data includes a first logic gate 210, a second logic gate 211, a logical operation value selector 220, a logical operation value controller 230, and a data outputting unit 240.

The apparatus 200 for generating random data generates a random function using physically unclonable function (PUF) logic. The apparatus 200 for generating random data may be provided in a data encryption apparatus for encrypting data in order to prevent a side channel attack (SCA). The data encryption apparatus uses random data output from the apparatus 200 for generating random data when data to be ciphered are masked. The data encryption apparatus uses symmetric key encryption when encrypting data, wherein the symmetric key encryption performs encryption when a key used to encrypt data is the same as a key used to decrypt the encrypted data.

The first logic gate 210 and the second logic gate 211 serve to logically operate first data and second data. In the exemplary embodiment, the types of the first logic gate 210 and the second logic gate 211 are different from each other. For example, when the first logic gate 210 is implemented by an AND gate, while the second logic gate 211 is implemented by an OR gate.

The logical operation value selector 220 uses a predetermined reference data to serve to select any one of logical operation values from the first logic gate 210 and logical operation values from the second logic gate 211. The logical operation value selector 220 may be implemented by a multiplexer. For example, when the first logic gate 210 is an AND gate and the second logic gate 211 is an OR gate, the logical operation value selector 220 may select the logical operation values from the first logic gate 210 when the first data is 1 and may select the logical operation values from the second logic gate 211 when the first data is 0.

The logical operation value controller 230 serves to input the selected logical operation values as the second data to the first logic gate 210 and the second logic gate 211.

The data outputting unit 240 serves to output the selected logical operation values as the random data.

In the exemplary embodiment, the apparatus 200 for generating random data includes at least two groups including the first logic gate 210, the second logic gate 211, and the logical operation value selector 220. In this configuration, the data outputting unit 240 collects the logical operation values selected from each group and outputs them as the random data.

The apparatus 200 for generating random data may further include a main controller (not shown) and a power supply unit (not shown). The main controller serves to control the entire operation of each component of the apparatus 200 for generating random data. In addition, the power supply unit serves to supply power to each component of the apparatus 200 for generating random data. Further, the apparatus 200 for generating random data may be provided in the data encryption apparatus for encrypting data. In connection with this, the apparatus 200 for generating random data according to the exemplary embodiment may not include the main controller and the power supply unit separately.

The apparatus 200 for generating random data may further include a logical operation value inverter 250. The logical operation value inverter 250 inverts the selected logical operation value and serves to input the inverted logical operation values as the second data by the logical operation value controller 230. In the exemplary embodiment, the logical operation value inverter 250 may be implemented by connecting an odd number of NOT gates in series.

The apparatus 200 for generating random data may further include a data storage unit (not shown) and a data storage controller. The data storage unit storing data may be implemented by, for example, a register. The data storage controller serves to store the input data in the data storage unit using a control signal each time the input data are received and store the second data in the data storage unit using the control signal when the input data are not received. In this case, the control signal implies a mode selection control signal. Meanwhile, the apparatus 200 for generating random data may further include a mode selector 262. The mode selector 262, which selects a specific mode among at least two modes by the control signal, serves to guide the input data or the second data to the data storage unit according to the selected mode.

Meanwhile, in the exemplary embodiment, the first logic gate 210 and the second logic gate 211 may use the input data as the first data. The logical operation value selector 220 first uses the input data as reference data and then uses data received from the data storage unit as reference data.

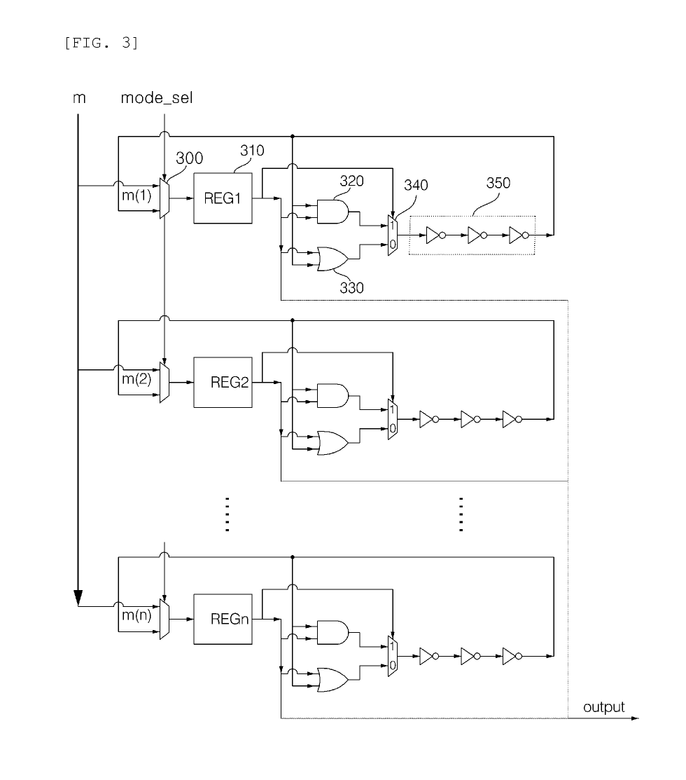

Next, an exemplary embodiment of the apparatus 200 for generating random data will be described. FIG. 3 is an exemplified diagram of the apparatus for generating random data. The following description refers to FIG. 3.

As shown in FIG. 3, the apparatus 200 for generating random data shown in FIG. 3, which is an apparatus for generating physically unclonable function (PUF) random masking, may be simply implemented by logics for generating random masking after a register 310. The detailed operating sequence is as follows.

First, a cipher algorithm input data m is stored in the register 310 by controlling a first MUX 300 with a mode_sel signal as an initial value. Next, when the register storing value is 1, the AND gate 320 is used and when the register value is 0, the OR gate 330 is used. The AND output or the OR output is selected from a second MUX 340 according to the register values. Thereafter, the data selected from the second MUX 340 is inverted by a NOT buffer 350. The inverted data are again input the AND gate 320, the OR gate 330, the register 310, or the like. In order to increase randomness, the NOT buffer 350 uses any odd stage. As a result, a signal where 0 and 1 is repeated rapidly, similar to a clock signal, is output from the final NOT buffer. Even though the logics are same, when theses signal are changed according to the process status, the values stored in the register have randomness after any signal. The present exemplary embodiment uses these random data as the masking values.

Even though the circuit shown in FIG. 3 is implemented originally, it is difficult to extract the random masking values for the side channel attack due to the characteristics of the PUF of which the operation is changed according to the process status. The same random masking values for the same m may be output within a single chip. However, the different input data m should be used for the side channel statistical analysis. However, when the different input data m is used, the masking values should be continuously changed accordingly. As a result, it is difficult to substantially perform the side channel statistical analysis. The exemplary embodiment may easily implement the cryptographic operation apparatus safe against the side channel analysis using small logics while considering these characteristics.

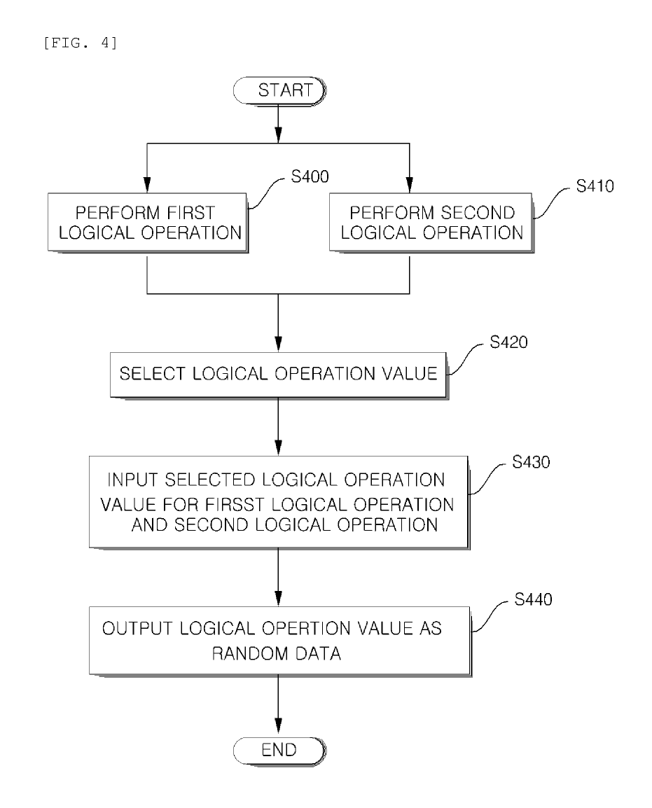

Next, a method for generating random data using the apparatus 200 for generating random data will be described will be described. FIG. 4 is a flow chart showing a method for generating random data according to an exemplary embodiment of the present invention. The description will be described below with reference to FIG. 4.

The method for generating random data according to the present exemplary embodiment is performed in the data encryption apparatus for encrypting data. In this case, the data encryption apparatus masks the data to be ciphered by using the random data generated and output accord to the method for generating random data. The method for generating random data will be described in more detail below.

First, the first data and the second data are logically operated by the first logic gate 210 (first logical operating step (S400)). In addition, the first data and the second data are logically operated by the second logic gate 211 different from the type of the first logic gate 210 (second logical operating step (S410)). The first logical operation step (S400) and the second logical operating step (S410) are performed simultaneously but is not necessarily limited thereto.

Thereafter, the logical operation value selector 220 uses the predetermined reference data to select any one of the logical operation values from the first logical operation step (S400) and the logical operation values from the second logical operation step (S410) (logical operation value selecting step (S420)). For example, when the first logic gate 210 is an AND gate and the second logic gate 211 is an OR gate, the logical operation value selecting step (S420) may select the first logical operation values from the first logic gate 210 when the first data is 1 and may select the logical operation values from the second logic gate 211 when the first data is 0.

Thereafter, the logical operation value controller 230 serves to input the selected logical operation value as the second data to the first logic gate 210 and the second logic gate 211 (logical operation value inputting step (S430)).

Thereafter, the data outputting unit 240 outputs the selected logical operation values as the random data (data outputting step (S440)).

The exemplary embodiment simultaneously performs the first logical operating step (S400), the second logical operating step (S410), the logical operating value selecting step (S420), and the logical operating value inputting step (S430) in at least two groups. In this case, the data outputting step (S440) collects the logical operation values selected from each group and outputs them as the random data.

As an intermediate step between the logical operation value selecting step (S420) and the logical operation value selecting step (S430), the logical operation value inverter 250 may invert the selected logical operation values (logical operation value inverting step). For example, the logical operation value inverting step may use an odd number of the NOT gates connected in series to invert the selected logical operation values. In this case, the inverted logical operation values are input as the second data by the logical operation value controller 230.

As the preceding step of the first logical operation step (S400) or the intermediate step between the logical operation value selecting step (S420) and the logical operation value inputting step (S430), the data storing controller may use the control signal to store the input data each time the input data are received and use the control signal to store the second data when the input data are not received (data storing step). When the input data are stored, the preceding step of the first logical operating step (S400) may be performed and when the second data is stored, the intermediate step between the logical operation value selecting step (S420) and the logical operation value inputting step (S430) may be performed. Meanwhile, as the previous step of the data storing step, the mode selector may guide the input data or the second data to the data storing unit for storing data by the control signal according to the specific mode selected among at least two modes (mode selecting step).

Meanwhile, the first logical operation step (S400) and the second logical operation step (S410) may use the input data as the first data. In addition, the logical operation value selecting step (S420) may first use the input data as the reference data and then, use the data received from the data storing unit as the reference data.

The present invention can be applied to the data encryption apparatus for encrypting data. More particularly, the present invention can be applied to the data encryption apparatus using the symmetric key encryption mechanism for preventing the side channel attack. The random data generated according to the present exemplary embodiment can be used when the data encryption apparatus masks the data to be ciphered.

Hitherto, the present invention has been described based on the exemplary embodiments. It will be appreciated by those skilled in the art that various modifications, changes, and substitutions can be made without departing from the essential characteristics of the present invention. Accordingly, the exemplary embodiments disclosed in the present invention and the accompanying drawings are used not to limit but to describe the spirit of the present invention. The protection scope of the present invention must be analyzed by the appended claims and it should be analyzed that all spirits within a scope equivalent thereto are included in the appended claims of the present invention.

What is claimed is:

1. An apparatus for generating random data, comprising:
a first logic gate logically operating first data and second data;
a second logic gate logically operating the first data and the second data and different from a type of the first logic gate;
a logical operation value selector selecting any one of logical operation values from the first logic gate and logical operation values of the second logic gate by using predetermined reference data;
a logical operation value controller inputting the selected logical operation values as the second data to the first logic gate and the second logic gate; and
a data outputting unit outputting the selected logical operation values as the random data.

2. The apparatus of claim 1, further comprising at least two groups including the first logic gate, the second logic gate, and the logical operation value selector,
wherein the data outputting unit collects the logical operation values selected from each group and outputs the collected logical operation values as the random data.

3. The apparatus of claim 1, further comprising a logical operation value inverter inverting the selected logical operation values and inputting the inverted logical operation values as the second data by the logical operation value controller.

4. The apparatus of claim 3, wherein the logical operation value inverter is configured by connecting an odd number of NOT gates in series.

5. The apparatus of claim 1, further comprising:
a data storage unit storing data; and
a data storing controller storing the input data in the data storing unit using a control signal each time the input data are received and storing the second data in the data storage unit using the control signal when the input data are not received.

6. The apparatus of claim 5, further comprising a mode selector selecting a specific mode among at least two modes by the control signal and guiding the input data or the second data to the data storage unit according to the selected mode.

7. The apparatus of claim 5, wherein the first logic gate and the second logic gate use the input data as the first data, and
the logical operation value selector first uses the input data as the reference data and then, uses the data received from the data storage unit as the reference data.

8. The apparatus of claim 1, wherein the first logic gate is an AND gate and the second logic gate is an OR gate, and
the logical operation value selector selects the logical operation values from the first logic gate when the first data is 1 and selects the logical operation values from the second logic gate when the first data is 0.

9. The apparatus of claim 1, wherein the apparatus for generating random data is provided in a data encryption apparatus for encrypting data, and
the data encryption apparatus uses the random data output from the data outputting unit when encrypting the data to mask the data to be ciphered.

10. The apparatus of claim 9, wherein the data encryption apparatus uses symmetric key encryption when encrypting the data.

11. A method for generating random data, comprising:
a first logical operating step of logically operating first data and second data using a first logic gate;
a second logical operating step of logically operating the first data and the second data using a second logic gate different from the type of the first logic gate;
a logical operation selecting step of selecting any one of the logical operation values from the first logical operating step and the logical operation values from the second logical operation step by using a predetermined reference data;
a logical operation inputting step of inputting the selected logical operation values as the second data to the first logical gate and the second logical gate; and
a data outputting step of outputting the selected logical operating value as the random data.

12. The method of claim 11, further comprising simultaneously performing the first logical operation step, the second logical operation step, the logical operation value step, and the logical operation value inputting step in at least two groups,
wherein the data outputting step collects the logical operation values selected from each group and outputs the collected logical operation values as the random data.
